(19) United States
(12) Patent Application Publication
(10) Pub. No.: US 2007/0204461 A1
(43) Pub. Date: Sep. 6, 2007

(54) Method of manufacturing bearing device for a wheel

(76) Inventors: Taku Nishiki, Shizuoka (JP); Kiyoshige Yamauchi, Shizuoka (JP); Mitsuru Umekida, Shizuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/709,820

(22) Filed: Feb. 23, 2007

(30) Foreign Application Priority Data
Feb. 24, 2006 (JP) 2006-048871

(51) Int. Cl. B21D 53/26; B23P 17/00

(52) U.S. Cl. 29/894.361; 29/894; 29/894.3; 29/898.07

(57) ABSTRACT

Provided is a method of manufacturing a bearing device for a wheel provided with: a hub wheel (2) having a flange (1) extending radially outward; a constant-speed universal joint (4) having an outer joint member (3) fixed to the hub wheel (2) ; an external member (5) disposed on outer periphery sides of the hub wheel (2) and the outer joint member (3); and rolling bodies (6) interposed between the external member (5) and the hub wheel (2) and between the external member (5) and the outer joint member (3), respectively. The method includes: assembling the hub wheel (2), the constant-speed universal joint (4), the external member (5), and the rolling bodies (6) to produce a subassembly body (S); and machining a mounting surface (21) of the flange (1) of the hub wheel (2) to which a brake rotor is attached, while the hub wheel (2) and the outer joint member (3) are rotated about an axis (O) of the subassembly body (S) with the external member (5) of the subassembly body (S) being fixed.

### BACKGROUND OF THE INVENTION

1. Field of the Invention

The present invention relates to a method of manufacturing a bearing device for a wheel.

2. Description of the Related Art

The history of bearing devices for wheels can be traced through four generations (see JP 2003-49853 A and JP 2005-349928 A). In each of the bearing devices for wheels of first and second generations, a pair of inner races are fitted (press-fitted) inside a hub wheel. In the bearing device for a wheel of a third generation, a raceway surface (rolling surface) is directly formed on an outer periphery of a hub wheel. Further, in the bearing device for a wheel of a fourth generation, the raceway surfaces (rolling surfaces) are directly formed on outer peripheries of the hub wheel and an outer joint member of a constant-speed universal joint, respectively.

As shown in, for example, FIG. 9, the bearing device for a wheel of the fourth generation is equipped with a hub wheel 102 having a flange 101 extending radially outward, a constant-speed universal joint 104 having an outer joint member 103 fixed to the hub wheel 102, an external member 105 disposed on outer periphery sides of the hub wheel 102 and the outer joint member 103, and rolling bodies 106 interposed between the hub wheel 102 and the external member 105 and between the outer joint member 103 and the external member 105, respectively.

The constant-speed universal joint 104 is equipped with the outer joint member 103, an inner joint member 108 disposed within a bowl-shaped portion 107 of the outer joint member 103, a rolling body 109 disposed between the inner joint member 108 and the outer joint member 103, and a retainer 110 for retaining the rolling body 109. An end of a shaft 111 is inserted into and fixed to the inner joint member 108, and a boot 112 for covering an opening portion of the bowl-shaped portion 107 of the outer joint member 103 is fitted to the shaft 111 and the bowl-shaped portion 107 of the outer joint member 103.

The hub wheel 102 has a tube portion 113 and the flange 101, and a raceway surface 114 is provided on an outer peripheral surface of the tube portion 113 on the bowl-shaped portion 107 side. A shaft portion 115 of the outer joint member 103 is inserted into the tube portion 113 of the hub wheel 102, and an end 115a of the shaft portion 115 of the outer joint member 103 is plastically deformed outward in a radial direction and caulked onto an end surface of an end 102a of the hub wheel 102, so the hub wheel 102 and the outer joint member 103 are integrated with each other. A raceway surface 119 is provided on an outer peripheral surface of the outer joint member 103.

Two-rowed raceway surfaces 116 and 117 are provided on an inner periphery of the external member 105, and a flange (vehicle body-mounted flange) 118 is provided on an outer periphery of the external member 105. One of the raceway surfaces, that is, the raceway surface 116 of the external member 105 and the raceway surface 114 of the hub wheel 102 surface each other. The other one of the raceway surfaces, that is, the raceway surface 117 of the external member 105 and the raceway surface 119 of the outer joint member 103 surface each other. The rolling bodies 106 are interposed between the raceway surfaces 116 and 114 and between the raceway surfaces 117 and 119, respectively.

The flange 101 of the hub wheel 102 is fitted with a hub bolt 120 for fitting a brake rotor (not shown) and a wheel (not shown) onto the flange 101. That is, the brake rotor is superposed on a mounting surface 121 of the flange 101 of the hub wheel 102, and the flange 101 and the brake rotor are coupled to each other via the hub bolt 120. The vehicle body-mounted flange 118 of the external member 105 is fastened and mounted on a vehicle body by means of bolts.

As described above, the brake rotor and the wheel are fitted on the flange 101 of the hub wheel 102, and the brake rotor is clamped by a caliper to decelerate or stop the wheel.

Thus, when the rotational run-out of the brake rotor has a high amplitude, an oscillatory phenomenon called brake judder occurs at the time of braking. The run-out of the brake rotor is attributed to the run-out of the flange. Thus, brake judder can be suppressed by reducing the amplitude of the run-out of the flange 101. Accordingly, it is necessary to finish the mounting surface 121 of the flange 101 with high accuracy so as to prevent the run-out of the flange 101.

Conventionally, respective parts (members) are finished with high accuracy and then assembled. Accordingly, it is necessary to finish the respective parts with high accuracy in order to enhance the accuracy in preventing the run-out of the mounting surface 121 of the flange 101.

However, even when the individual parts are finished with high accuracy, the accuracy in preventing the run-out of the flange of the assembled bearing device for a wheel cannot be ensured with ease because a post-assemblage accuracy results from accumulation of accuracies of the individual parts. In addition, when the respective individual parts are finished with high accuracy, the time required for an entire manufactural operation becomes long, and the cost of manufacture becomes high.

### SUMMARY OF THE INVENTION

The present invention has been made in consideration of the problems mentioned above. It is therefore an object of the present invention to provide a method of manufacturing a bearing device for a wheel which makes it possible to perform high-accuracy finish enabling prevention of the run-out of a flange with ease and to suppress the occurrence of brake judder.

According to the present invention, there is provided method of manufacturing a bearing device for a wheel provided with: a hub wheel having a flange extending radially outward; a constant-speed universal joint having an outer joint member to be fixed to the hub wheel; an external member disposed on outer periphery sides of the hub wheel and the outer joint member; and rolling bodies interposed between the external member and the hub wheel and between the external member and the outer joint member, respectively, the method including: assembling the hub wheel, the constant-speed universal joint, the external member, and the rolling bodies to produce a subassembly body; and machining a mounting surface of the flange of the hub wheel to which a brake rotor is attached, while the hub wheel and the outer joint member are rotated about an axis of the subassembly body with the external member of the subassembly body being fixed.

After the hub wheel, the outer joint member, the external member, and the rolling bodies are assembled, the mounting surface of the flange is finished. Thus, the mounting surface of the flange can be finished with high accuracy without finishing the individual parts with high accuracy.

The bearing device for a wheel may be obtained either by inserting a shaft portion of the outer joint member into a hole portion of the hub wheel to integrate the hub wheel and the outer joint member with each other or by inserting a shaft portion of the hub wheel into a hole portion of the outer joint member to integrate the hub wheel and the outer joint member with each other.

In the method of manufacturing the bearing device for a wheel according to the present invention, there is no need to finish the individual parts with high accuracy, so the cost of manufacture can be lowered and the time required for the manufactural operation can be shortened. In addition, the mounting surface of the flange is turned after the hub wheel, the outer joint member, the external member, and the rolling bodies are assembled, so the run-out of the flange can be regulated with high accuracy. Thus, the occurrence of brake judder in the bearing device for a wheel can be suppressed effectively.

### BRIEF DESCRIPTION OF THE DRAWINGS

In the accompanying drawings:

FIG. 1 is a sectional view of a bearing device for a wheel which is manufactured according to a manufacturing method of the present invention;

FIG. 2 is a sectional view of a finished state of the bearing device in the manufacturing method of the present invention;

FIG. 3 is a sectional view of a bearing device for a wheel according to a first modified example of the present invention;

FIG. 4 is a sectional view of a bearing device for a wheel according to a second modified example of the present invention;

FIG. 5 is a sectional view of a bearing device for a wheel according to a third modified example of the present invention;

FIG. 6 is a sectional view of a bearing device for a wheel according to a fourth modified example of the present invention;

FIG. 7 is a sectional view of a bearing device for a wheel according to a fifth modified example of the present invention;

FIG. 8 is a sectional view of a bearing device for a wheel according to a sixth modified example of the present invention; and

FIG. 9 is a sectional view of a conventional bearing device for a wheel.

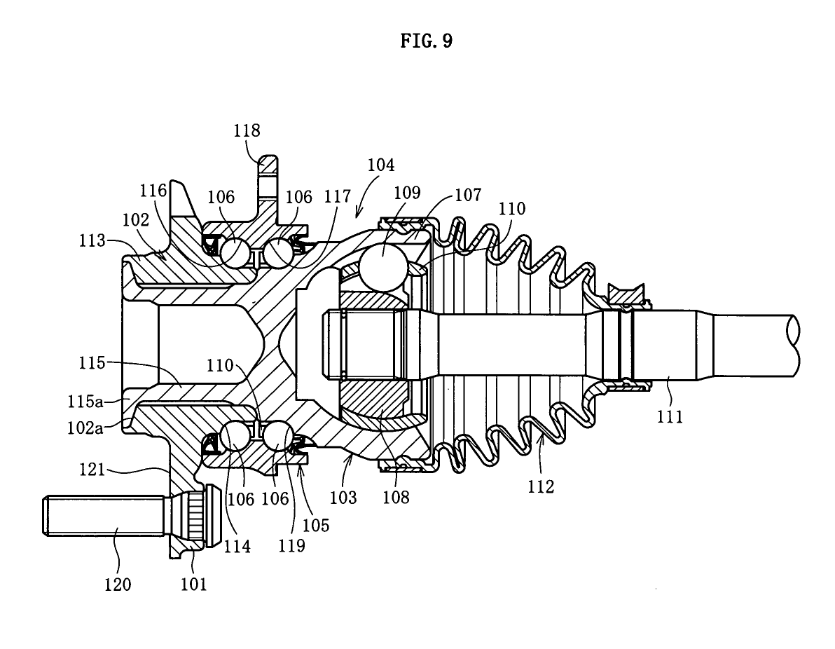

### DETAILED DESCRIPTION OF THE PREFERRED EMBODIMENTS

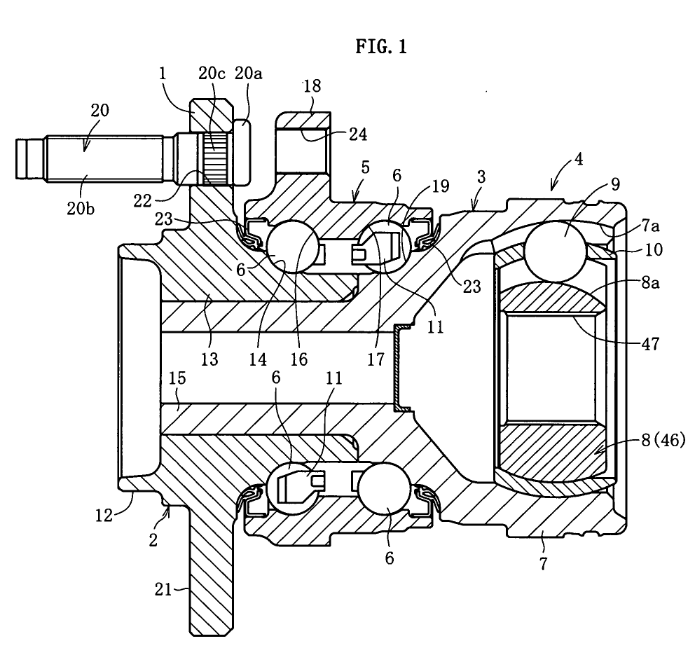

Embodiments of the present invention will be described hereinafter with reference to FIGS. 1 to 8.

FIG. 1 shows a bearing device for a wheel which is manufactured according to a manufacturing method of the present invention. The bearing device for a wheel belongs to the fourth generation, which is marked by a structure in which raceway surfaces (rolling surfaces) are directly formed on outer peripheries of a hub wheel and an outer joint member of a constant-speed universal joint, respectively. The bearing device for a wheel is equipped with a hub wheel 2 having a flange 1 extending radially outward, a constant-speed universal joint 4 having an outer joint member 3 fixed to the hub wheel 2, an external member 5 disposed on outer periphery sides of the hub wheel 2 and the outer joint member 3, and rolling bodies 6 interposed between the external member 5 and the hub wheel 2 and between the external member 5 and the outer joint member 3, respectively.

The constant-speed universal joint 4 is equipped with the outer joint member 3, an inner joint member 8 disposed in a bowl-shaped portion 7 of the outer joint member 3, a plurality of balls 9 disposed between the inner joint member 8 and the outer joint member 3, and a retainer 10 for retaining the balls 9. An end of a shaft (not shown) is inserted into and fixed to the inner joint member 8. The outer joint member 3 is provided with a tubular shaft portion 15 protruded from a base (bottom) of the bowl-shaped portion 7, and a raceway surface 19 is formed on an outer periphery of the bowl-shaped portion 7 on the base side thereof.

Track grooves 8a are formed in an outer peripheral surface of an inner race 46 as the inner joint member 8. Track grooves 7a, which are equal in number to the track grooves 8a of the inner joint member 8, are formed in an inner peripheral surface of the bowl-shaped portion 7 of the outer joint member 3. The balls 9 for transmitting torque are incorporated between the track grooves 7a of the outer joint member 3 and the track grooves 8a of the inner joint member 8.

The end of the shaft (not shown) is inserted into and fixed to the inner joint member 8. That is, a center hole of the inner race 46 as the inner joint member 8 is provided with a spline (or serration) portion 47. The end of the shaft is inserted into the center hole of the inner race 46 to mesh a spline (or serration) portion of the end with the spline (or serration) portion 47 of the inner race 46.

The hub wheel 2 has a tube portion 13 and the flange 1, and a raceway surface 14 is provided on an outer peripheral surface of the tube portion 13 on the bowl-shaped portion 7 side. The shaft portion 15 of the outer joint member 3 is inserted (press-fitted) into the tube portion 13 of the hub wheel 2, so the hub wheel 2 and the outer joint member 3 are integrated with each other.

Two-rowed raceway surfaces 16 and 17 are provided on an inner periphery of the external member 5, and a flange (vehicle body-mounted flange) 18 is provided on an outer periphery of the external member 5. One of the raceway surfaces 16 of the external member 5 and the raceway surface 14 of the hub wheel 2 surface each other. The other raceway surface 17 of the external member 5 and the raceway surface 19 of the outer joint member 3 surface each other. The rolling bodies 6 are interposed between the raceway surfaces 16 and 14 and between the raceway surfaces 17 and 19, respectively. The rolling bodies 6 are retained by retainers 11, and a screw hole 24 is provided through the vehicle body-mounted flange 18.

The flange 1 of the hub wheel 2 is fitted with a plurality of hub bolts 20 for fitting a brake rotor (not shown) and a wheel (not shown) thereto. That is, a plurality of through-holes (press-fit holes) 22 are provided at predetermined pitches through the flange 1 along a circumferential direction thereof, and the hub bolts 20 are press-fitted into the through-holes 22, respectively. Each of the hub bolts 20 is equipped with a head portion 20a, a screw shaft portion 20b, and a serration portion 20c between the screw shaft portion 20b and the head portion 20a. The serration portion 20c of each of the hub bolts 20 is press-fitted into a corresponding one of the through-holes 22.

The brake rotor is superposed on a mounting surface 21 of the flange 1 of the hub wheel 2 on the brake rotor side, and the flange 1 and the brake rotor are coupled to each other via the hub bolts 20. The vehicle body-mounted flange 18 of the external member 5 is fastened and mounted on a vehicle body by means of bolts.

Seals 23 and 23 are fitted on the external member 5 on both end sides thereof. That is, the seals 23 prevent foreign matters from entering the bearing and also prevent grease filling the interior of the bearing from leaking out.

To prevent an oscillatory phenomenon called brake judder, which occurs at the time of braking, it is necessary to prevent the run-out of the flange 1. In the present invention, therefore, the mounting surface 21 on the brake rotor side is turned.

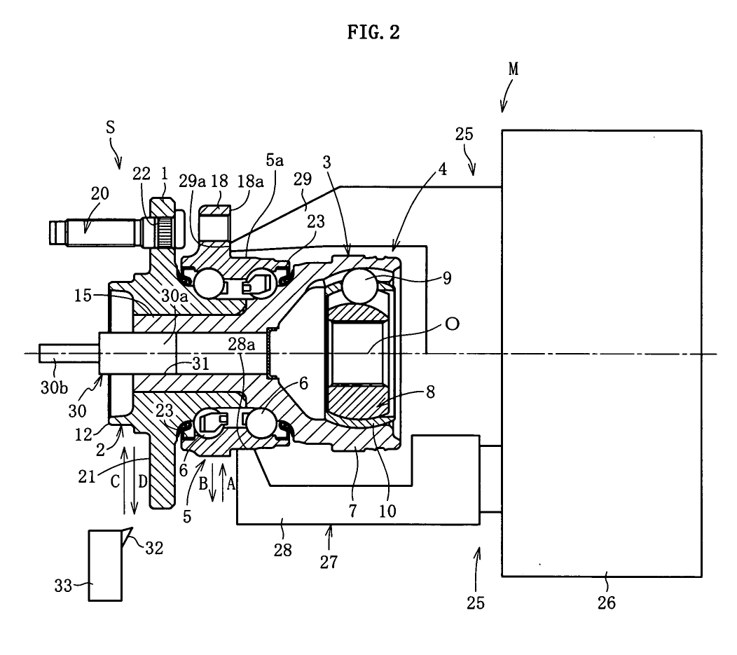

Next, a method of turning the mounting surface 21 on the brake rotor side by using a turning device M equipped with retention means 25 as shown in FIG. 2 will be described. In this case, first of all, the hub wheel 2, the constant-speed universal joint 4, the external member 5, and the rolling bodies 6 are assembled to form a subassembly body S. The seals 23 and 23 remain fitted on the external member 5.

While the external member 5 is retained by the retention means 25, the hub wheel 2 and the outer joint member 3 of the constant-speed universal joint 4 are rotated around an axis O of a body assembled as described above (subassembly body) S, namely, around an axis of the outer joint member 3. The mounting surface 21 on the brake rotor side is thereby turned.

The retention means 25 is equipped with a base 26, and a chuck pawl mechanism 27 protruded from the base 26. The chuck pawl mechanism 27 is equipped with a first pawl member 28 for receiving a tubular body portion 5a of the external member 5, and a second pawl member 29 for supporting a lateral surface 18a of the flange 18 of the external member 5 on a side thereof which is not mounted to the wheel. The first pawl member 28 can be reciprocated in a radial direction perpendicular to the axis O by a drive mechanism (reciprocation mechanism) (not shown) as indicated by arrows A and B of FIG. 2.

A support shaft member 30, which is coupled to an output shaft of a drive mechanism (not shown) such as a motor, is inserted into a hole portion 31 of the shaft portion 15 of the outer joint member 3. In this case, a tip chuck portion 29a of the second pawl member 29 is abutted on the lateral surface 18a of the flange 18 of the external member 5, and the first pawl member 28 is moved closer to the external member 5 side from a radially outward direction as indicated by the arrow A until a tip chuck portion 28a of the first pawl member 28 is abutted on an outer peripheral surface of the tubular body portion 5a of the external member 5. The support shaft member 30 is composed of an inserted shaft portion 30a inserted into the hole portion 31 of the shaft portion 15 of the outer joint member 3, and a protruded shaft portion 30b protruded from the inserted shaft portion 30a.

In a state set as described above, the drive mechanism such as the motor is driven, so the hub wheel 2 and the outer joint member 3 can be rotated around the axis O with the external member 5 fixed. With the hub wheel 2 and the outer joint member 3 thus being rotated, a turning head 33 having a turning blade 32 is radially operated as indicated by arrows C and D, so the mounting surface 21 on the brake rotor side is machined or turned by the turning blade 32. Thus, the mounting surface 21 on the brake rotor side can be finished. Due to this finish, the amplitude of the run-out of end surfaces of the hub wheel 2 (run-out of the flange 1) can be made equal to or smaller than 20 μm.

In the method of manufacturing the bearing device for a wheel according to the present invention, there is no need to finish the individual parts with high accuracy, so the cost of manufacture can be lowered and the time required for the manufactural operation can be shortened. In addition, the mounting surface 21 of the flange 1 is turned after the hub wheel 2, the outer joint member 3, the external member 5, and the rolling bodies 6 are assembled, so the run-out of the flange 1 can be regulated with high accuracy. Thus, the occurrence of brake judder in the bearing device for a wheel can be suppressed effectively.

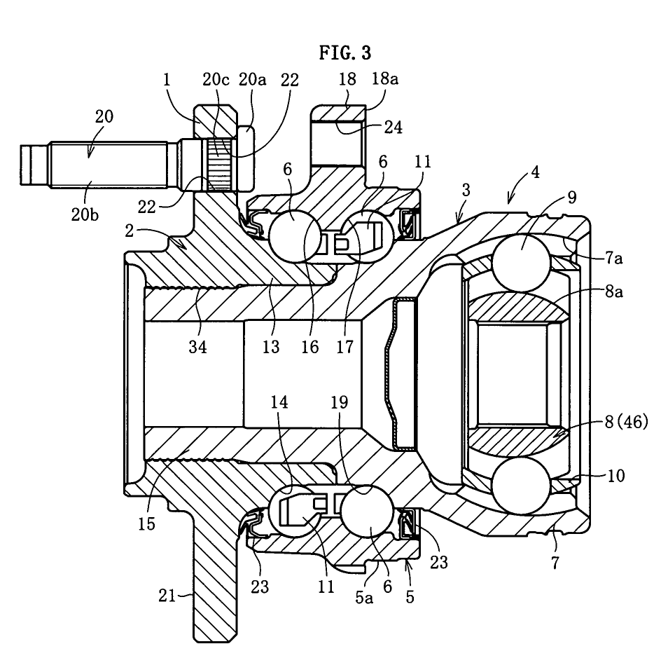

Reference is made next to FIG. 3 which shows a modified example of the bearing device for a wheel. In this bearing device for a wheel, an inner peripheral surface of the hub wheel 2 on the other side of the bowl-shaped portion 7 is provided with an irregularity portion 34, and convex parts of the irregularity portion 34 are plastically coupled to an outer peripheral surface of the shaft portion 15 of the outer joint member 3 on the other side of the bowl-shaped portion 7. That is, the shaft portion 15 of the outer joint member 3 is enlarged in diameter, so the convex parts of the irregularity portion 34 are plastically coupled to the outer peripheral surface of the shaft portion 15. The bearing device for a wheel shown in FIG. 3 is identical to the bearing device for a wheel shown in FIG. 1 in other constructional details. Referring to FIG. 3, therefore, components and portions identical to those of the bearing device for a wheel shown in FIG. 1 are denoted by the same reference symbols as in FIG. 1 and will not be described hereinafter.

Accordingly, even in the bearing device for a wheel shown in FIG. 3 as well as the bearing device for a wheel shown in FIG. 1, the mounting surface 21 of the flange 1 can be turned by using the turning device M as shown in FIG. 2, with the hub wheel 2, the constant-speed universal joint 4, the external member 5, and the rolling bodies 6 being assembled.

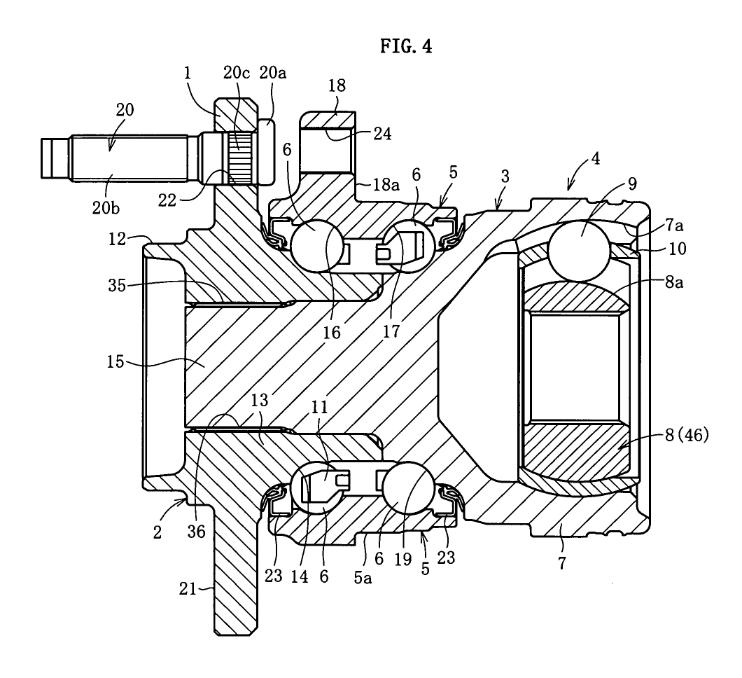

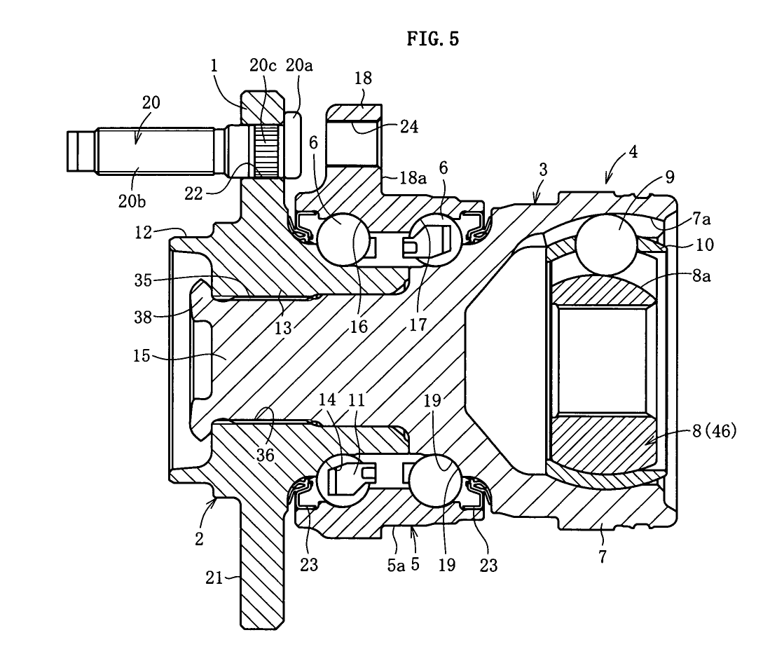

Referring to FIGS. 4 and 5, the shaft portion 15 of the outer joint member 3 is constructed as a cylindrical body. In each of those bearing devices for the wheels shown in FIGS. 4 and 5, a spline (or serration) portion 35 is formed on the outer peripheral surface of the shaft portion 15 on the other side of the bowl-shaped portion 7, and a spline (or serration) portion 36 for meshing with the spline (or serration) portion 35 of the shaft portion 15 is formed on the inner peripheral surface of the hub wheel 2 on the other side of the bowl-shaped portion 7. In the bearing device for a wheel shown in FIG. 5, the end of the shaft portion 15 is protruded from the tube portion 13 of the hub wheel 2, and the protruded portion is caulked radially outward to form a caulked portion 38. The bearing devices for the wheels shown in FIGS. 4 and 5 are identical to the bearing device for a wheel shown in FIG. 1 in other constructional details. Referring to FIG. 4 and 5, therefore, components and portions identical to those of the bearing device for a wheel shown in FIG. 1 are denoted by the same reference symbols as in FIG. 1 and will not be described hereinafter.

In the bearing devices for the wheels shown in FIGS. 4 and 5, the shaft portion 15 of the outer joint member 3 is not tubular and thus cannot be supported by the support shaft member 30 as shown in FIG. 2. Thus, a component fitted to a wheel pilot 12 or the like of the hub wheel 2 is used as a member for supporting the shaft portion 15.

Accordingly, even in the bearing devices for the wheels shown in FIGS. 4 and 5 as well as the bearing device for a wheel shown in FIG. 1, the mounting surface 21 of the flange 1 can be turned with the hub wheel 2, the constant-speed universal joint 4, the external member 5, and the rolling bodies 6 being assembled.

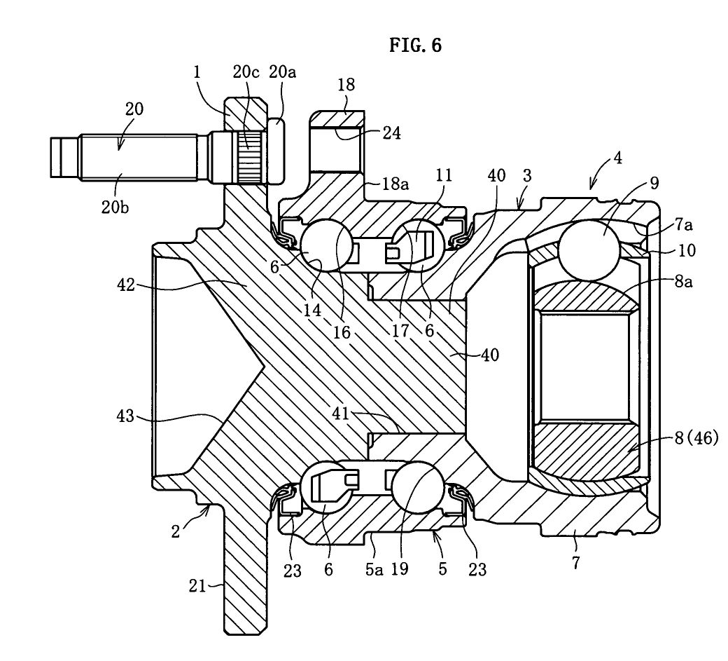

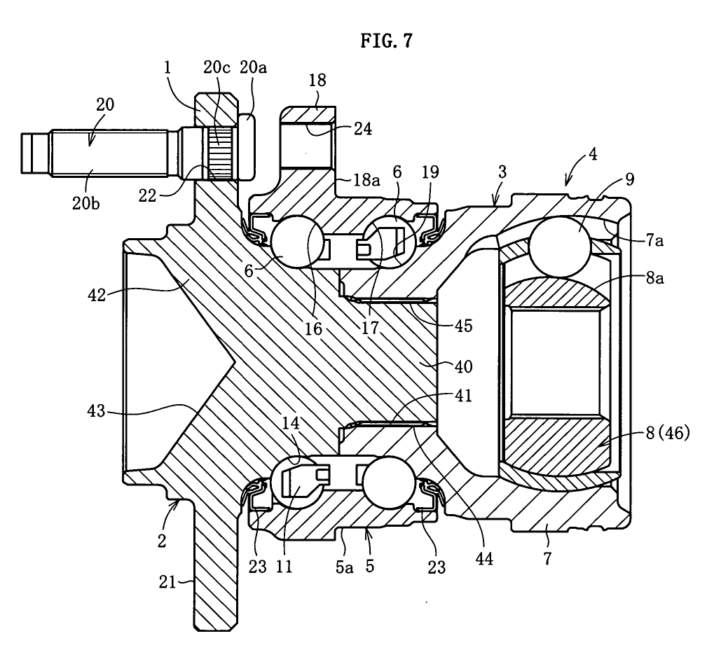

In each of bearing devices for wheels shown in FIGS. 6 and 7, the hub wheel 2 is provided with a shaft portion 40, a through-hole 41 is provided through the bottom of the bowl-shaped portion 7 of the outer joint member 3, and the shaft portion 40 of the hub wheel 2 is inserted into the through-hole 41 of the outer joint member 3.

That is, the hub wheel 2 in this case is composed of a solid hub wheel body portion 42 having the flange 1 on an outer periphery thereof, and the shaft portion 40 protruding from the hub wheel body portion 42. A conical depressed portion 43 is provided in an end surface of the hub wheel body portion 42 on the other side of the shaft portion 40.

In the bearing device for a wheel shown in FIG. 6, the shaft portion 40 of the hub wheel 2 is press-fitted into the through-hole 41 of the outer joint member 3. In the bearing device for a wheel shown in FIG. 7, a spline (or serration) portion 44 is provided on an outer peripheral surface of the shaft portion 40 of the hub wheel 2, and a spline (or serration) portion 45 for meshing with the spline (or serration) portion 44 of the hub wheel 2 is formed on an inner peripheral surface of the through-hole 41 of the outer joint member 3.

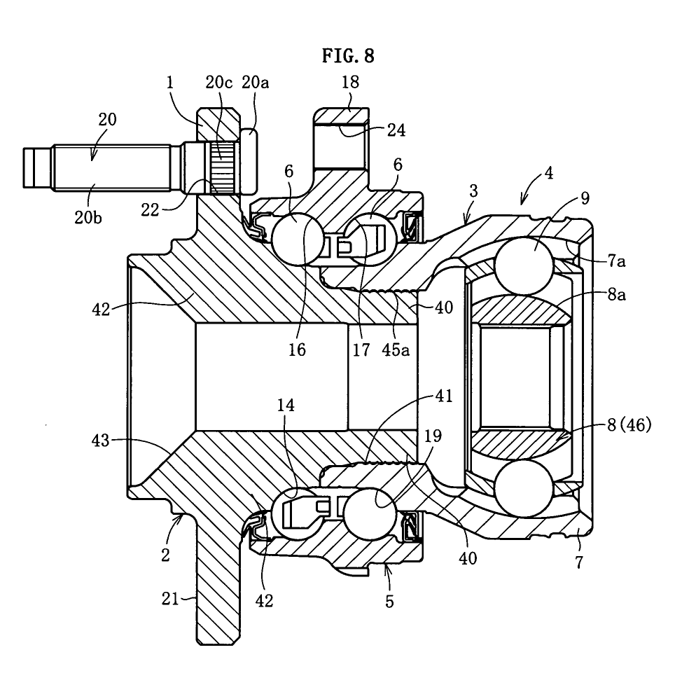

In a bearing device for a wheel shown in FIG. 8, the hub wheel body portion 42 and the shaft portion 40 are both tubular, and an irregularity portion 45a is formed on the inner peripheral surface of the through-hole 41 of the outer joint member 3. Convex parts of the irregularity portion 45a are plastically coupled to the outer peripheral surface of the shaft portion 40 of the hub wheel 2.

The bearing devices for the wheels shown in FIGS. 6 to 8 are identical to the bearing device for a wheel shown in FIG. 1 in other constructional details. Referring to FIGS. 6 to 8, therefore, components and portions identical to those of the bearing device for a wheel shown in FIG. 1 are denoted by the same reference symbols as in FIG. 1 and will not be described hereinafter.

Accordingly, even in the bearing devices for the wheels shown in FIGS. 6 to 8 as well as the bearing device for a wheel shown in FIG. 1, the mounting surface 21 of the flange 1 can be turned with the hub wheel 2, the constant-speed universal joint 4, the external member 5, and the rolling bodies 6 being assembled.

Although the embodiments of the present invention have been described above, the present invention is not limited to the aforementioned embodiments thereof and can be modified in various manners. For example, the bearing device for a wheel may be designed for either a driven wheel or a driving wheel. Although the rolling bodies 6 are designed as balls in the embodiments of the present invention, conical rollers may be used as the rolling bodies 6.

What is claimed is:

1. A method of manufacturing a bearing device for a wheel provided with: a hub wheel having a flange extending radially outward; a constant-speed universal joint having an outer joint member to be fixed to the hub wheel; an external member disposed on outer periphery sides of the hub wheel and the outer joint member; and rolling bodies interposed between the external member and the hub wheel and between the external member and the outer joint member, respectively,
the method comprising:
assembling the hub wheel, the constant-speed universal joint, the external member, and the rolling bodies to produce a subassembly body; and
machining a mounting surface of the flange of the hub wheel to which a brake rotor is attached, while the hub wheel and the outer joint member are rotated about an axis of the subassembly body with the external member of the subassembly body being fixed.

2. A method of manufacturing a bearing device for a wheel according to claim 1, wherein the assembling includes inserting a shaft portion of the outer joint member into a hole portion of the hub wheel so that the hub wheel and the outer joint member are integrated with each other.

3. A method of manufacturing a bearing device for a wheel according to claim 1, wherein the assembling includes inserting a shaft portion of the hub wheel into a hole portion of the outer joint member so that the hub wheel and the outer joint member are integrated with each other.
